(19) United States
(12) Patent Application Publication
(10) Pub. No.: US 2005/0000113 A1
(43) Pub. Date: Jan. 6, 2005

(54) Textile machine with recirculating air heating effected by gas-heated head exchangers

(76) Inventor: Helge Freiberg, Monchengladbach (DE)

Correspondence Address: WILLIAM COLLARD;COLLARD & ROE, P.C., 1077 NORTHERN BOULEVARD, ROSLYN, NY, 11576, US

(21) Appl. No.: 10/490,353

(22) PCT Filed: Jul. 11, 2003
(86) PCT No.: PCT/DE03/02326

(30) Foreign Application Priority Data
Jul. 25, 2002 (DE) 102 33 754.3

(51) Int. Cl. F26B 9/00

(52) U.S. Cl. 34/611

(57) ABSTRACT

A textile machine having circulating air heating by means of gas-heated heat exchangers, having flame or meander tubes arranged parallel to one another in a suction space, crosswise to the air stream of the latter, and burners switched ahead of them, is described. In order to be able to work with two burners in the case of high required heat output, and nevertheless to heat the air stream drawn in by the heat exchanger equally, in the case of indirect circulating air heating, everywhere in the stream cross-section, two burners, each having a subsequent tube heat exchanger, are each assigned to one half of the suction space, whereby the heating tubes of the two heat exchangers reach over the entire suction space width, in the main part of the suction space, crosswise to its air stream, but extend only over the suction space half assigned to the burner, in each instance, at least in a segment of the circulating air stream path in the suction space.

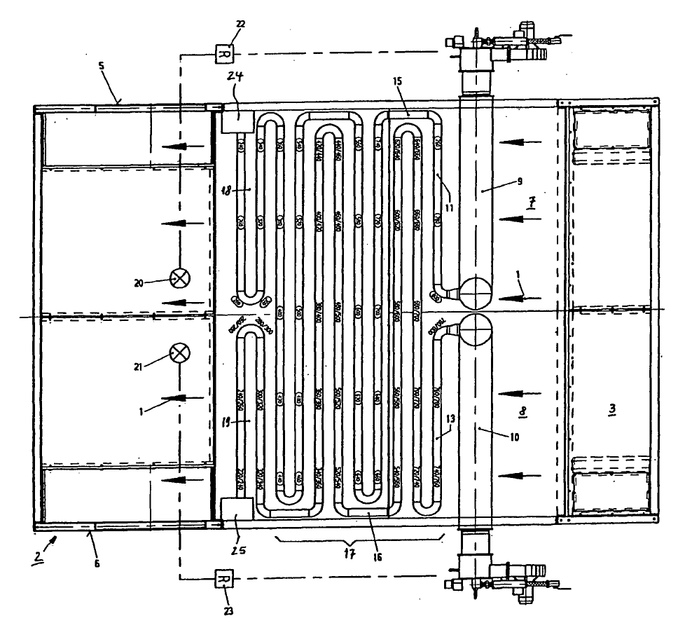

The invention relates to a textile machine having circulating air heating by means of gas-heated heat exchangers, having flame tubes arranged parallel to one another in a suction space, crosswise to the air space of the latter, particularly meander tubes, and burners switched ahead of them. Preferably, flow through adjacent flame tubes is supposed to take place in anti-parallel manner. The textile machine preferably has a device for indirect heating of the treatment gas, in the housing of which a cross-counter-current recuperator configured by means of the invention is arranged.

The circulating air heating is provided, in the case of convection drying machines and/or fixing machines, for the thermal treatment of a textile web of material. Examples of such machines are stentering frames and hot flues (see these key words in Koch, Satlow, Grosses Textil-Lexikon [Big Textile Encyclopedia], Deutsche Verlags-Anstalt Stuttgart, 1996). Devices for continuous shrinkage treatment of textile webs of material and machines for drying filament warps or coated carpets, according to DE-PS 27 54 438, belong to the area of application of the invention.

DE 100 47 834 A1 describes a textile machine having a device for indirect heating of the treatment gas, which contains a cross-counter-current recuperator arranged in a housing. The recuperator is structured in such a manner that the sum of the temperature values that are measured on a straight line in the circulating air stream direction, in each instance, at the flame tube parts which the line hits, is the same everywhere in the cross-section of the heat exchanger (that lies perpendicular to the circulating air stream). The energy transferred in the heat exchanger is applied by a burner.

In the case of conventional textile machines of the type indicated above, combustion gases intended for heating are directly mixed with the circulating air; one then speaks of direct heating. The combustion gases, which are generally produced by burning gas or oil, then come into direct contact with the textile web of material. If this is supposed to be avoided, the aforementioned indirect heating can be used.

In the case of indirect heating, heat exchangers having oil circulation or steam heating are generally used. These heat exchangers guarantee that the circulating air stream to be heated, the volume and cross-section of which (determined by the consumption in the jet system to be supplied) are relatively large, is given the same temperature everywhere in the stream cross-section. The latter is a prerequisite for the fact that the treatment agent stream formed by the circulating air stream, e.g. in jet boxes, has the same temperature everywhere on the treated surface of the textile web of material. This advantage is achieved at great expense, however, if heating systems for operation of heat exchangers heated by means of circulating oil or steam are absent at the user's facilities, in other words significant additional investments are required even if application cases with indirect heating occur only now and then.

If a very great output is demanded in the textile machine in question, which is to be heated, e.g. in a hot flue, it is difficult for the required amount of energy to be applied by only a single large burner. Instead, it has proven to be more advantageous, in practice, to use two smaller burners. However, the general requirement of heating the textile web of material that is to be treated evenly everywhere on its surface, particularly on every line crosswise to the transport direction, must also be fulfilled when using two burners.

If two smaller burners are provided instead of one large burner, in the case of the directly heated machines, a uniform distribution of the circulating air temperature on the surface of the web of material crosswise to the circulating air stream can be achieved if each of the two burners has its own temperature regulation circuit. In this connection, the temperature sensor for the burner located on one side (e.g. the right) is arranged in that fan housing that is assigned to the same side, in other words the right side of the web of material, while the temperature sensor for the burner on the other (left) side is arranged in the fan housing that is located there (i.e. on the left). The two partial streams are mixed with one another in various suction and pressure spaces, using complicated circulating air mixers, so that a uniform temperature distribution is achieved over the width of the web of material, in every case, when it impacts the material. The separate temperature regulation is necessary because it is hardly possible to control both burners in absolutely equal manner from a single regulator. This is attributable to the tolerance and the hysteresis of the regulating valves for the energy supply, e.g. the gas supply.

According to a recognition on which the invention is based, it appears necessary, in the case of indirect heating of the treatment gas, to provide a separate heat exchanger for each of the (smaller) burners. Nevertheless, it is desirable, in the sense of the aforementioned DE 100 47 834 A1, to eliminate the complicated circulating air mixers in order to achieve an air stream that is equally tempered everywhere over its cross-section. Instead, it should be possible to arrange and configure the flame tubes in such a manner that the sum of the temperature values that are measured on each line parallel to the circulating air stream, from flame tube to flame tube, is the same everywhere in the cross-section (that lies perpendicular to the circulating air stream) of the total heat exchanger channel assigned to the burners in common.

The invention is based on the task of achieving these goals for two burners for indirect heating of the treatment gas with a cross-counter-current recuperator, whereby each of the two burners is supposed to contain its own temperature regulation circuit with its own temperature sensor and its own regulating valve (for the energy supply).

For the textile machine described initially, the solution according to the invention consists in the fact that two burners, each having a subsequent tube heat exchanger, are each assigned to one half (the right and the left half, respectively) of the suction space, and that the flame tubes of the two heat exchangers reach over the entire suction space width, in the main part of the suction space, crosswise to its air stream, but extend only over the suction space half assigned to the burner, in each instance, at least in a segment of the circulating air stream path in the suction space. In other words: In order to be able to work with two burners in the case of high required heat output, and nevertheless to heat the air stream drawn in by the heat exchanger equally, in the case of indirect circulating air heating, everywhere in the stream cross-section, the burners, each having a subsequent tube heat exchanger, are each assigned to one part of the suction space, whereby the heating tubes of the two heat exchangers reach over the entire suction space width in the main part of the suction space, crosswise to its air stream, but extend only over the suction space part assigned to the burner, in each instance, in at least one part of the air stream path in the suction space. Some improvements and additional embodiments of the invention are indicated in the dependent claims.

According to the invention, the tubes of the two heat exchanger parts are arranged in such a manner that in the main part of the heat exchanger, one tube layer of the first heat exchanger alternates with one of the second heat exchanger, in each instance. In this connection, the combustion gases flow within the flame tubes, while the circulating air to be transported to the textile web of material and heated is passed around the tubes. The heat exchange takes place at the surface of the tubes, the heat of the combustion air is passed to the circulating air there.

According to the invention, the flame tubes of the two heat exchangers are passed over the entire width of the suction space in their main part, preferably in meander shape. In at least one segment, preferably the first and/or the last segment, on the circulating air path through the suction space, the flame tubes in which the combustion gases of the one burner, e.g. the right burner flow, are passed only through the right half of the suction space, while the flame tubes of the other burner, in other words the left burner, lie only in the left half of the suction space. Fundamentally, what is involved is part of the suction space. Subsequent to the heat exchanger, the combustion gases are passed into a collector and drawn out of the machine from there.

Because the flame tubes are located only in the half of the suction space that belongs to one of the burners, on a segment of the circulating air path through the heat exchanger, separate temperature regulation of the circulating air on this half, and therefore regulation of the related burner, is made possible.

The partial division of the heat exchanger, according to the invention, can preferably be provided at the beginning and/or at the end of the circulating air path in the suction space. The divided segment of the heat exchanger can, however, fundamentally be arranged at any location of the heat exchanger, e.g. also somewhere in the middle of the circulating air path.

By means of the invention, a heat exchanger supplied by two burners, for indirect circulating air heating, is created, which allows precise, separate regulation of the two burners, but can be produced with significantly less effort than if each burner had a separate heat exchanger assigned to it, in total. The heat exchanger, which is not divided, for the most part, according to the invention, can be produced more inexpensively, for example, than two separate heat exchangers, since only half of the welding work has to be performed in the undivided part of the heat exchanger (as compared with complete division).

For precise regulation of the two burners, it has proven to be sufficient if less than ten percent (in general, two meander loops, or preferably, a single meander loop is sufficient) is divided in the sense of the invention. A cross-counter-current recuperator according to the invention, for indirect heating of a treatment gas, possessed four flame tube loops that extend over the entire width, crosswise to the circulating air stream, which are supplied by each of the burners, and, for each burner in addition, one flame tube loop that extends over half of the circulating air cross-section.

Details of the invention will be explained using a schematic exemplary embodiment.

The attached drawing shows a heat exchanger channel 2 cut parallel to the circulating air stream 1. The heat exchanger channel 2 possesses an input 3 and an output 4 and longitudinal walls 5 and 6 that lie opposite one another. The channel 2 comprises a right half 7 and a left half 8. The halves 7 and 8 each have a burner 9 and 10 assigned to them. Two flame tubes 11 and 13, respectively, are supplied by each burner. The flame tubes are preferably guided through the heat exchanger channel 2 in meanders 15, 16 that run anti-parallel to one another. The meander tubes 11 and 13 in the drawing run crosswise to the circulating air stream 1 and meander in the direction of the circulating air stream 1.

In a main part 17 of the meander 15, 16, the flame tubes 11 as well as the flame tubes 13 are passed back and forth crosswise over the entire heat exchanger channel 2, in other words from longitudinal wall 5 to longitudinal wall 6. In a segment 18 or 19, respectively, which is located at the end of the channel 2 in the circulating air stream direction, in the exemplary embodiment, in contrast, the flame tubes 11 meander only in the right half 7 and the flame tubes 13 meander only in the left half 8 of the heat exchanger channel 2. These segments 18, 19 each have a temperature sensor 20, 21 assigned to them, which controls the related burner 9 or 10, respectively, by way of a regulator 22 or 23, respectively (along the line of effect as shown in the drawing), in such a manner that the circulating air stream 1 that exits at the output 4 has the same temperature everywhere, over the entire circulating air stream cross-section, from the longitudinal wall 5 to the longitudinal wall 6 (and crosswise to this direction). After the heat exchanger, the combustion gases can be passed into a collector by way of heating outlets 24, 25, and from there drawn out of the machine.

The following example will show how the temperature regulation according to the invention can work: It is assumed that the combustion gases of the right burner 9 are 20° Celsius hotter than the combustion gases of the left burner 10 (800° Celsius as compared with 780° Celsius). For the sake of simplicity, it is furthermore assumed that this is also the surface temperature of the tubes 11 and 13, respectively, at the inlet. The combustion gases cool down as a result of the heat transfer to the circulating air, in the manner indicated by the temperature information shown in the drawing. If the surface temperatures of three stream paths of the circulating air, in each instance, are now followed in the right and the left half 7, 8, and if the surface temperatures of the circulating air stream paths, in each instance, are added, it is found that in the right half 7, in other words where the combustion gases flowed into the tube bundles at a slightly higher temperature, higher temperature sums are also obtained than in the left half 8 (sum of the surface temperatures in the right stream paths 5,700/5,680/5,660° Celsius; sum of the surface temperatures in the left stream phases 5,600/5,620/5,640° Celsius). The sensor 20 of the right burner 9 gives the latter a signal to throttle the supply of energy until the actual value of the left burner 10 has been reached.

### REFERENCE SYMBOL LIST

| | |
|---|---|
| 1 = | circulating air stream |
| 2 = | heat exchanger channel |
| 3 = | input |
| 4 = | output |
| 5 = | left longitudinal wall |
| 6 = | right longitudinal wall |
| 7 = | right half |
| 8 = | left half |
| 9 = | right burner |
| 10 = | left burner |
| 11 = | flame tubes (28) |
| 13 = | flame tubes (29) |
| 15 = | meander (28) |
| 16 = | meander (29) |
| 17 = | main part |
| 18 = | right divided tube segment |
| 19 = | left divided tube segment |
| 20 = | right temperature sensor |
| 21 = | left temperature sensor |
| 22 = | right regulator |
| 23 = | left regulator |
| 24 = | right heating gas outlet |
| 25 = | left heating gas outlet |

1. Textile machine having circulating air heating by means of gas-heated heat exchangers, having flame tubes (11 and 13) arranged parallel to one another in a suction space, crosswise to the air stream (1) of the latter, and burners (9, 10) switched ahead of them, wherein two burners (9, 10), each having a subsequent tube heat exchanger, are each assigned to one half (7, 8) (the right and the left half, respectively) of the suction space, and that the flame tubes (11 and 13) of the two heat exchangers reach over the entire suction space width, in the main part (17) of the suction space, crosswise to its air stream (1), but extend only over the suction space half (7, 8) assigned to the burner (9, 10), in each instance, at least in a segment (18, 19) of the circulating air stream path (1) in the suction space.

2. Textile machine according to claim 1, wherein the divided segment (18, 19) of the flame tubes (11 and 13) is located in the input region or in the output region of the air stream path (1).

3. Textile machine according to claim 1, wherein the divided segments (18, 19) of the flame tubes each have at least one temperature sensor (20, 21) assigned to them, and that the temperature sensors are switched with the related burner (9, 10) by way of a regulator (22, 23), in each instance.
